(19) United States
(12) Patent Application Publication
(10) Pub. No.: US 2025/0303345 A1
(43) Pub. Date: Oct. 2, 2025

(54) CARBON DIOXIDE RECOVERY APPARATUS

(71) Applicant: HONDA MOTOR CO., LTD., Tokyo (JP)

(72) Inventors: Ryo NINOMIYA, Saitama (JP); Toshiyuki INABA, Saitama (JP)

(21) Appl. No.: 19/069,247

(22) Filed: Mar. 4, 2025

(30) Foreign Application Priority Data
Mar. 28, 2024 (JP) 2024-053488
Dec. 19, 2024 (JP) 2024-224152

(51) Int. Cl. B01D 53/04

(52) U.S. Cl. CPC B01D 53/0438; B01D 2257/504; B01D 2258/06; B01D 2259/40098

(57) ABSTRACT

Provided is a carbon dioxide recovery apparatus including an adsorbent holder that holds an adsorbent and can be efficiently attached and detached, and capable of achieving high thermal efficiency. A carbon dioxide recovery apparatus includes: heat exchangers (adsorbent holders) holding an adsorbent; support plates (supports) each having a first receiving portion and a second receiving portion into which the heat exchangers are able to be slidably inserted; and seal portions disposed on the heat exchangers and capable of being deformed to follow the first receiving portion 81 and the second receiving portion when the heat exchangers are slidably inserted into the first receiving portion and the second receiving portion. The heat exchangers are supported by the support plate via the sealing portions.

This application is based on and claims the benefit of priority from Japanese Patent Application Nos. 2024-053488 and 2024-224152, respectively filed on 28 Mar. 2024 and 19 Dec. 2024, the contents of which are incorporated herein by reference.

### BACKGROUND OF THE INVENTION

### Field of the Invention

The present invention relates to a carbon dioxide recovery apparatus.

### Related Art

There is a known technique for recovering carbon dioxide from a carbon dioxide-containing gas such as atmospheric air. This type of technique is described, for example, in US Patent Application, Publication No. 2019/0255480. For example, US Patent Application, Publication No. 2019/0255480 discloses that a plurality of adsorbents for adsorbing carbon dioxide are disposed in layers on an adsorbent holding member. Japanese Unexamined Patent Application (Translation of PCT Application), Publication No. 2017-528318 describes a method of separating gaseous carbon dioxide from a gas mixture by means of cyclic adsorption/desorption using an adsorbent for adsorbing gaseous carbon dioxide.
Patent Document 1: US Patent Application, Publication No. 2019/0255480
Patent Document 2: Japanese Unexamined Patent Application (Translation of PCT Application), Publication No. 2017-528318

### SUMMARY OF THE INVENTION

In the case of a configuration in which a heat exchanger that heats and cools an adsorbent is used as an adsorbent holder, it is necessary to remove the heat exchanger from a casing for replacement of the adsorbent. The operation for removing the heat exchanger involves removal of other assembled components, in addition to removal of the heat exchanger. In the case of a configuration in which a plurality of heat exchangers including adsorbents are arranged in the vertical direction, the operation for setting the heat exchangers in a casing involves stacking the heat exchangers one by one from the bottom. As described above, it takes considerable time and effort to attach and detach a heat exchanger.

In addition, there are some heat exchangers formed by brazing aluminum parts due to structural reasons, resulting in a large dimensional tolerance. Such a large dimensional error leads to a large gap between the casing and the heat exchanger. The gap is a factor that causes a decrease in the amount of air passing through the adsorbent, and may reduce the carbon dioxide recovery rate.

An object of the present invention is to provide a carbon dioxide recovery apparatus including an adsorbent holder that holds an adsorbent and can be efficiently attached and detached, and capable of achieving high thermal efficiency.

A first aspect of the present invention is directed to a carbon dioxide recovery apparatus (e.g., a carbon dioxide recovery apparatus 1 described later) including: an adsorbent holder (e.g., a heat exchanger 70 described later) holding an adsorbent (e.g., an adsorbent 12 described later); a support (e.g., a support plate 80 described later) having a receiving portion (e.g., a first receiving portion 81 and a second receiving portion 82 described later) into which the adsorbent holder is able to be slidably inserted; and a seal portion (e.g., a seal portion 75 described later) disposed on the adsorbent holder and capable of being deformed to follow the receiving portion when the adsorbent holder is slidably inserted into the receiving portion. The adsorbent holder is supported by the support via the sealing portion.

According to a second aspect of the present invention, in the carbon dioxide recovery apparatus of the first aspect, the seal portion may be made of a foamable material.

According to a third aspect of the present invention, in the carbon dioxide recovery apparatus of the first or second aspect, the adsorbent holder may include a plurality of adsorbent holders, and the receiving portion may include a first receiving portion (e.g., a first receiving portion 81 described later) in which one of the plurality of adsorbent holders is received, and a second receiving portion (e.g., a second receiving portion 82 described later) which is located next to the first receiving portion and in which another of the plurality of adsorbent holders is received, and the carbon dioxide recovery apparatus may further include a guide member (e.g., a guide member 90) that is inserted between the adsorbent holders received in the first and second receiving portions, and that presses the seal portion (e.g., a seal portion 75 described later) of each of the adsorbent holders.

According to a fourth aspect of the present invention, in the carbon dioxide recovery apparatus of the third aspect, the first receiving portion may be inclined such that a leading end of the first receiving portion in an insertion direction of the adsorbent holder is closer to the second receiving portion than a back end of the first receiving portion in the insertion direction, the second receiving portion may be inclined such that a leading end of the second receiving portion in the insertion direction is closer to the first receiving portion than a back end of the second receiving portion in the insertion direction, and the guide member may have a wedge shape tapered toward a leading end in the insertion direction.

According to a fifth aspect of the present invention, the carbon dioxide recovery apparatus of the first or second aspect may further include: a header (e.g., a header 110 described later) through which a heat transfer medium flows; a pipe (e.g., a flanged pipe 120 described later) that establishes communication between an interior of the adsorbent holder and an interior of the header and allows the heat transfer medium to flow into the adsorbent holder; and a heat insulating material (e.g., an O-ring 122 described later) disposed between the adsorbent holder and the pipe.

According to a sixth aspect of the present invention, the carbon dioxide recovery apparatus of the first or second aspect may further include: a casing (e.g., a casing 50 described later) to which the support is fixed; a header (e.g., a header 110 described later) which is disposed outside the casing and through which a heat transfer medium flows; a cylindrical portion (e.g., a cylindrical portion 121 described later) penetrating a wall of the casing and establishing communication between an interior of the adsorbent holder and an interior of the header; a flange (e.g., a flange 125 described later) provided on the cylindrical portion and disposed between the header and the casing; and a heat insulating material (e.g., an O-ring 126 and an O-ring 127 described later) disposed in at least one of a portion between the flange and the casing or a portion between the flange and the header.

According to a seventh aspect of the present invention, the carbon dioxide recovery apparatus of the first or second aspect may further comprises a heat insulating material (e.g., a heat insulating material 79 described later) disposed on at least part of a surface of the adsorbent holder (e.g., a heat exchanger 70 described later).

According to a seventh aspect of the present invention, the carbon dioxide recovery apparatus of the first or second aspect may further comprises a heat insulating material (e.g., a heat insulating material 79 described later) disposed on all surfaces of the adsorbent holder (e.g., a heat exchanger 70 described later) except for a portion in contact with the adsorbent.

The present invention provides a carbon dioxide recovery apparatus including an adsorbent holder that holds an adsorbent and can be efficiently attached and detached, and capable of achieving high thermal efficiency.

### BRIEF DESCRIPTION OF THE DRAWINGS

FIG. 1 is a schematic diagram illustrating a configuration of a carbon dioxide recovery apparatus according to an embodiment of the present invention;

FIG. 2 is a perspective view illustrating an appearance of a housing of the carbon dioxide recovery apparatus of the embodiment;

FIG. 3 is a perspective view illustrating an appearance of the housing of the carbon dioxide recovery apparatus of the embodiment in a state in which an intake part has been removed;

FIG. 4 is a perspective view illustrating an appearance of the housing in a state in which heat exchangers of the carbon dioxide recovery apparatus of the embodiment are pulled out;

FIG. 5 is a perspective view illustrating support plates with which the heat exchangers can be set inside a casing of the carbon dioxide recovery apparatus of the embodiment;

FIG. 6 is a side view illustrating an inner side surface of the support plate of the carbon dioxide recovery apparatus of the embodiment;

FIG. 7 is a perspective view of the heat exchanger of the carbon dioxide recovery apparatus of the embodiment;

FIG. 8 is a schematic view illustrating a state in which the heat exchangers are going to be received on the support plate of the carbon dioxide recovery apparatus of the present embodiment;

FIG. 9 is a perspective view illustrating a guide member that is going to be inserted into the support plate of the carbon dioxide recovery apparatus of the embodiment. FIG. 10 is a schematic view illustrating a state in which the heat exchangers and the guide member are received on the support plate of the carbon dioxide recovery apparatus of the embodiment;

FIG. 11 is a perspective view illustrating how the guide member is fixed after being inserted into the support plate of the carbon dioxide recovery apparatus of the embodiment;

FIG. 12 is a schematic view illustrating a structure for connecting the heat exchangers and a header of the carbon dioxide recovery apparatus of the embodiment;

FIG. 13 is a diagram illustrating, on an enlarged scale, a portion of the heat exchangers; and

FIG. 14 is a diagram illustrating a heat insulating material provided on the heat exchanger main body of the heat exchangers.

### DETAILED DESCRIPTION OF THE INVENTION

Embodiments of the present invention will be described with reference to the drawings.

### First Embodiment

### <Overall Configuration>

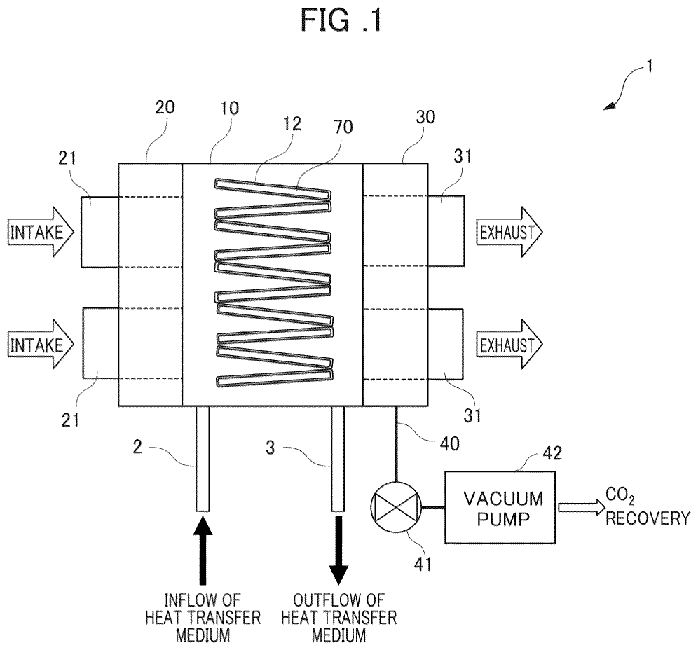

FIG. 1 is a schematic diagram illustrating a configuration of a carbon dioxide recovery apparatus 1 according to an embodiment of the present invention. The carbon dioxide recovery apparatus 1 is applicable to, for example, a direct air capture (DAC) technique for recovering carbon dioxide from atmospheric air in order to reduce the concentration of carbon dioxide in atmospheric air. The carbon dioxide recovered by the carbon dioxide recovery apparatus 1 is stored underground or reused as a fuel or a material.

As illustrated in FIG. 1, the carbon dioxide recovery apparatus 1 includes a housing 10, an intake part 20, an exhaust part 30, a recovery line 40, a recovery valve 41, and a vacuum pump 42.

The housing 10 houses heat exchangers 70. Each heat exchanger 70 is a radiator that has fins formed on an outer surface thereof and that includes therein a flow path through which a heat transfer medium flows. The heat transfer medium having a temperature potential corresponding to a process that is performed in the housing 10 is introduced into the heat exchangers 70. The heat transfer medium is introduced into the heat exchangers 70 in the housing 10 through an inflow line 2, exchanges heat inside the heat exchangers 70, and then returns to the outside of the housing 10 through an outflow line 3. When a desorption process is performed, the heat transfer medium having a high temperature for raising the temperature of an adsorbent 12 is supplied to the heat exchangers 70, whereby the temperature of the adsorbent 12 is raised. When an adsorption process is performed, the heat transfer medium having a low temperature is supplied to the heat exchangers 70, whereby the adsorbent 12 is cooled.

The adsorbent 12 is disposed on the heat exchangers 70. In the present embodiment, the adsorbent 12 is filled between fins formed on the outer surfaces of the heat exchangers 70, and the heat exchangers 70 function as adsorbent holders. The adsorbent 12 is heated or cooled by exchanging heat with the heat transfer medium flowing through the flow paths inside the heat exchangers 70.

The adsorbent 12 is a particulate member and has a property of adsorbing carbon dioxide in a state in which the adsorbent 12 is at a low temperature (e.g., in the range of −30° C. to 50° C.), and a property of desorbing (releasing) carbon dioxide in a state in which the adsorbent 12 is at a high temperature (e.g., in the range of 50° C. to 110° C.) and the surroundings have a low concentration of carbon dioxide. An example of the adsorbent 12 includes, but is not limited to, a solid amine carbon dioxide adsorbent constituted by a porous material such as silica and an amine supported thereon.

In the housing 10, the adsorption process and the desorption process are alternately performed. In the adsorption process, the adsorbent 12 adsorbs carbon dioxide from an introduced gas such as atmospheric air, whereas in the desorption process, the carbon dioxide adsorbed on the adsorbent 12 is desorbed by way of decompression-heating after generating a vacuum.

The intake part 20 introduces air containing carbon dioxide into the housing 10. Intake valves 21 are controlled to be in an open state during the adsorption process, and are controlled to be in a closed state during the desorption process.

The exhaust part 30 causes the air, which has been introduced during the adsorption process and from which carbon dioxide has been captured by the adsorbent 12, to exit from the housing 10 to the outside. The exhaust part 30 includes exhaust valves 31. The exhaust valves 31 are controlled to be in an open state during the adsorption process, and are controlled to be in a closed state during the desorption process.

The recovery line 40 is a pipe that is connected to the exhaust part 30 and that sends carbon dioxide desorbed from the adsorbent 12 in the desorption process to a carbon dioxide tank (not shown). The recovery line 40 is not necessarily connected to the exhaust part 30, and may be connected to the intake part 20, for example.

The recovery valve 41 is disposed at connection between the recovery line 40 and the housing 10. The recovery valve 41 is controlled to be in an open state in which the recovery line 40 and the interior of the housing 10 communicate with each other during the desorption process for recovering carbon dioxide, and is controlled to be in a closed state in which the recovery line 40 and the interior of the housing 10 are separated from each other during the adsorption process.

The vacuum pump 42 is disposed in the recovery line 40. By driving the vacuum pump 42, the carbon dioxide desorbed in the desorption process in the housing 10 is recovered into the carbon dioxide tank (not shown) through the recovery line 40.

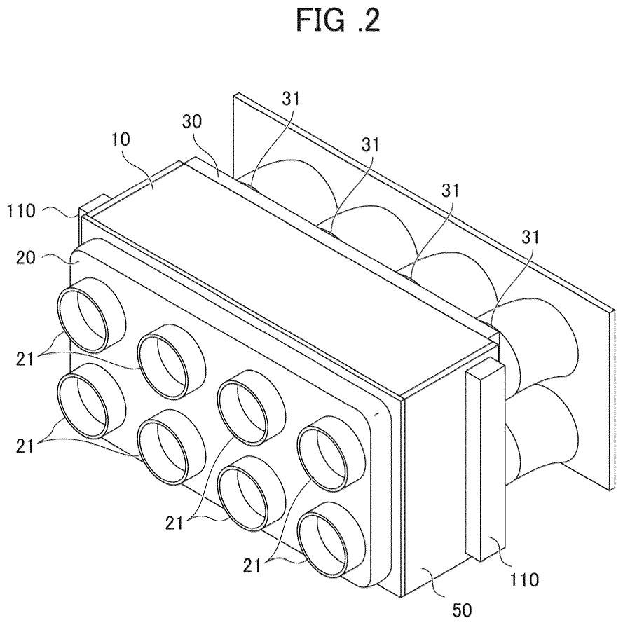

Structure for Attaching and Detaching Heat Exchangers Next, a structure for attaching and detaching the heat exchangers to and from the housing 10 will be described. FIG. 2 is a perspective view illustrating an appearance of the housing 10 of the carbon dioxide recovery apparatus 1 of the present embodiment. In the following description, the longitudinal direction of the heat exchangers 70 and the longitudinal direction of a casing 50 are defined as the left-right direction, for convenience.

The housing 10 includes the casing 50 in which the heat exchangers 70 are accommodated. The heat exchangers 70 are attachable to and detachable from the casing 50. Two headers 110 for causing the heat transfer medium to flow through the heat exchangers 70 are disposed on the casing 50. One of the two headers 110 is connected to the inflow line 2 (not shown in FIG. 2), and the other is connected to the outflow line 3 (not shown in FIG. 2).

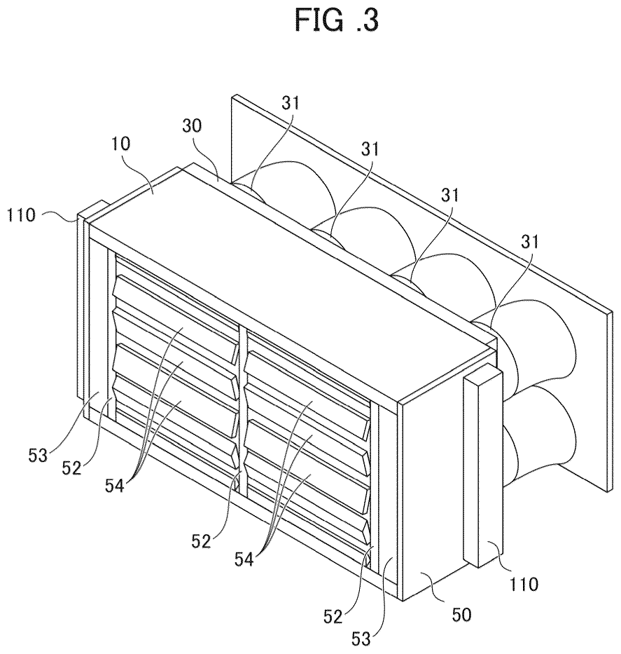

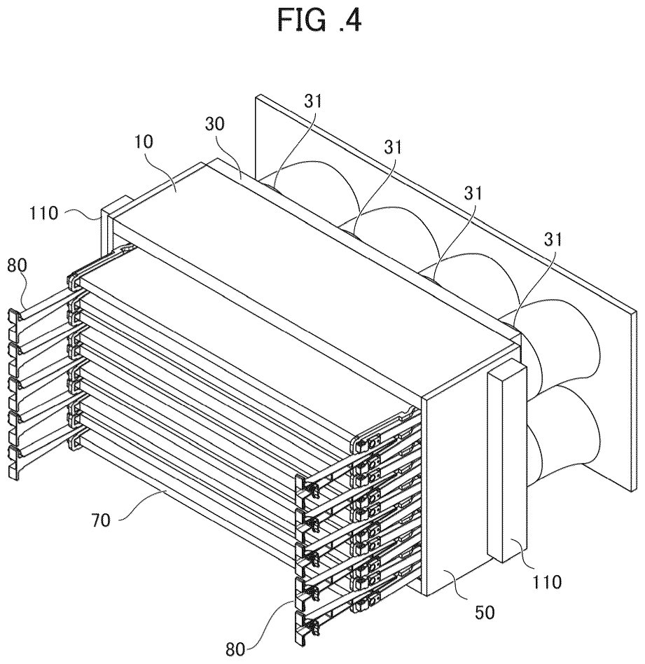

FIG. 3 is a perspective view illustrating an appearance of the housing 10 of the carbon dioxide recovery apparatus 1 of the present embodiment in a state in which the intake part 20 has been removed. As illustrated in FIG. 3, the housing 10 includes stays 52, vertical covers 53, and lateral covers 54 as fixing members for fixing the heat exchangers 70 accommodated in the casing 50. The stays 52 are belt-shaped members extending in the up-down direction, and a total of three stays 52 are disposed at the center and opposite sides in the left-right direction. The vertical covers 53 are fastened to the stays 52 on the opposite sides with bolts or the like, and cover left and right end portions of the heat exchangers 70. The lateral covers 54 are fastened to the stays 52 and the vertical covers 53 with bolts or the like, and cover pull-out sides of the heat exchangers 70. When the heat exchangers 70 are pulled out after removal of the stays 52, the vertical covers 53, and the lateral covers 54 from the state illustrated in FIG. 3, the housing 10 is brought into the state illustrated in FIG. 4.

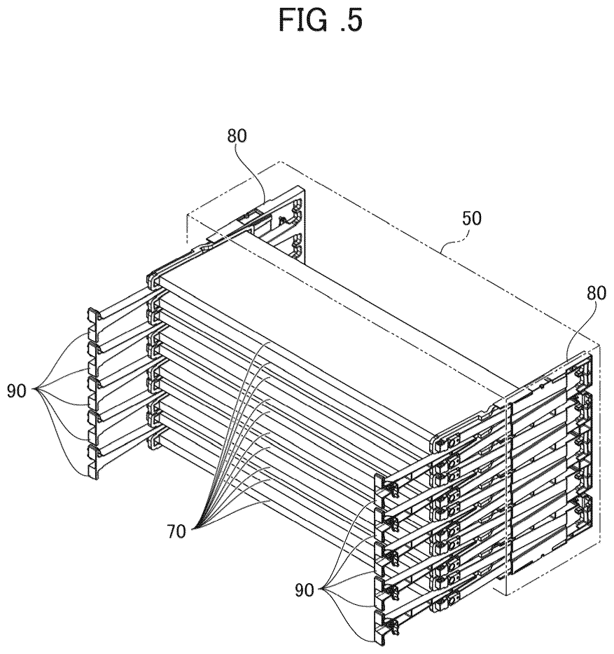

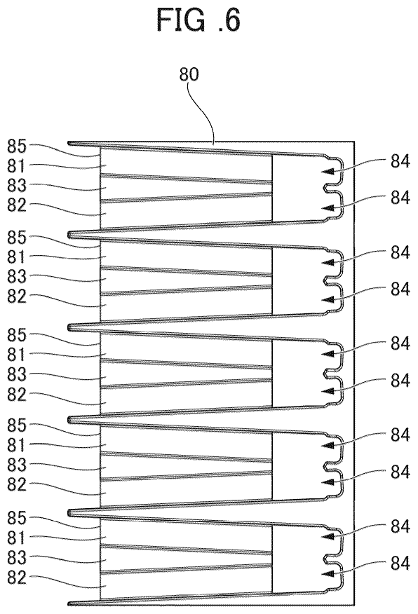

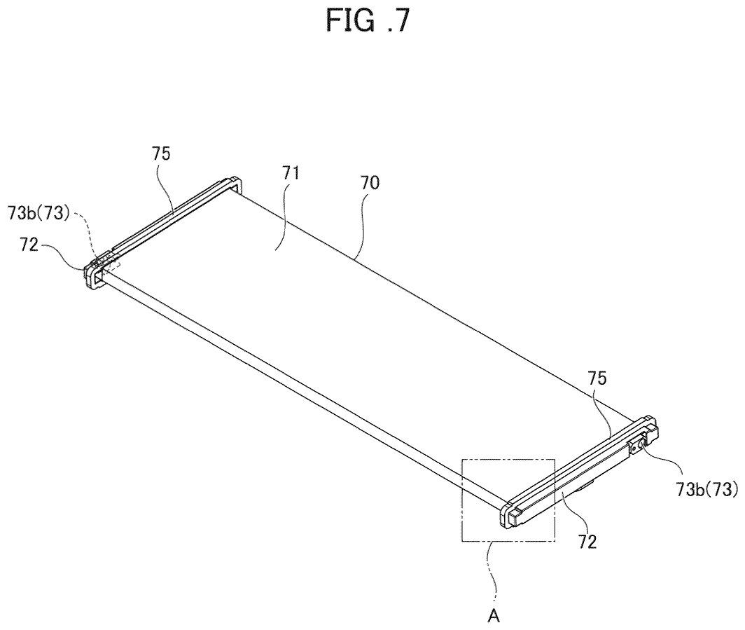

FIG. 4 is a perspective view illustrating an appearance of the housing 10 in a state in which the heat exchangers 70 of the carbon dioxide recovery apparatus 1 of the present embodiment are pulled out. FIG. 5 is a perspective view illustrating support plates 80 with which the heat exchangers 70 can be set inside the casing 50 of the carbon dioxide recovery apparatus 1 of the present embodiment. FIG. 6 is a side view illustrating an inner side surface of the support plate 80 of the carbon dioxide recovery apparatus 1 of the present embodiment. FIG. 7 is a perspective view of the heat exchanger 70 of the carbon dioxide recovery apparatus 1 of the present embodiment.

FIGS. 4 and 5 illustrate a state in which the heat exchangers 70 set on the support plates 80 have been pulled out. In the following description, the pull-out side may be referred to as the front side for convenience.

The present embodiment has a configuration in which when the intake part 20, the stays 52, the vertical covers 53, and the lateral covers 54 are removed, the heat exchangers 70 can be pulled out from the casing 50. This configuration makes it possible to take out the heat exchangers 70 and replace the adsorbent 12 while maintaining the components of the carbon dioxide recovery apparatus 1 except for the heat exchangers 70 in an assembled state.

As illustrated in FIG. 5, the support plates 80 are disposed on the left and right sides of the set of heat exchangers 70. As illustrated in FIG. 6, first receiving portions 81, second receiving portions 82, guide insertion portions 83, connection through holes 84, and connection notches 85 are formed in each support plate 80.

The first receiving portions 81 and the second receiving portions 82 are each a concavity formed on the inner side surface of the support plate 80. The first receiving portions 81 and the second receiving portions 82 are arranged such that one first receiving portion 81 and one second receiving portion 82 form a pair in the up-down direction.

The first receiving portions 81 and the second receiving portions 82 are provided in correspondence with the number of heat exchangers 70 to be received, and are arranged in a comb shape. In the example illustrated in FIG. 6, five pairs of the first receiving portions 81 and the second receiving portions 82 are arranged in the up-down direction, and accordingly, the support plates 80 are capable of supporting a total of ten heat exchangers 70.

Each first receiving portion 81 is inclined so that an inlet side thereof that is close to the inlet of the casing 50 is higher than a back side thereof in a side view. The inclination of the first receiving portion 81 is set so that the inlet side is inclined upward by about 2.5 degrees with respect to the horizontal direction. The second receiving portion 82 is inclined so that an inlet side thereof that is close to the inlet of the casing 50 is lower than a back side thereof in a side view. The inclination of the second receiving portion 82 is set so that the inlet side is inclined downward by about 2.5 degrees with respect to the horizontal direction. One first receiving portion 81 and one second receiving portion 82 that form a pair are arranged in a substantially V-shape whose spacing narrows from a back end toward a leading end in an insertion direction of the heat exchangers 70.

Each of the guide insertion portions 83 is a concavity formed between the first receiving portion 81 and the second receiving portion 82. The guide members 90 (to be described later) are inserted into the guide insertion portions 83. Although the concavity as the guide insertion portion 83 is less deep than the concavities as the first and second receiving portions 81 and 82, each guide insertion portion 83 is adjacent to the first and second receiving portions 81 and 82 without a partition therebetween.

The connection through holes 84 are formed on a leading end side of each first receiving portion 81 and on a leading end side of each second receiving portion 82 in the insertion direction, respectively. Each connection through hole 84 is a communication hole via which a flow path connection portion 73 (to be described later) formed in a leading end portion of the heat exchanger 70 in the insertion direction is connected to the header 110.

The connection notches 85 are formed on a back end side (front side) of each first receiving portion 81 and on a back end side (front side) of each second receiving portion 82 in the insertion direction. Each connection notch 85 is a communication notch via which a flow path connection portion 73 (to be described later) formed on a back end portion of the heat exchanger 70 in the insertion direction is connected to the header 110.

As illustrated in FIG. 7, each heat exchanger 70 of the present embodiment includes a heat exchanger main body 71, insertable portions 72, the flow path connection portions 73, and seal portions 75.

The heat exchanger main body 71 has therein a flow path through which the heat transfer medium flows. The heat exchanger main body 71 of the present embodiment has a substantially rectangular parallelepiped shape.

The insertable portions 72 are formed on opposite sides of the heat exchanger main body 71. The insertable portions 72 are inserted into the first receiving portions 81 or the second receiving portions 82.

The flow path connection portions 73 are connection holes via which the flow path in the heat exchanger main body 71 is connected to flow paths connected to the headers 110. The flow path connection portions 73 are formed in the end faces of the insertable portions 72 on the left and right sides, respectively.

The positions of the flow path connection portions 73 are different between the left and right insertable portions 72.

With reference to the page of FIG. 7, the flow path connection portion on the insertable portion 72 located on the right side is denoted by 73a, the flow path connection portion on the insertable portion 72 located on the left side is denoted by 73b, and the difference in position between the flow path connection portions 73a and 73b will be described below.

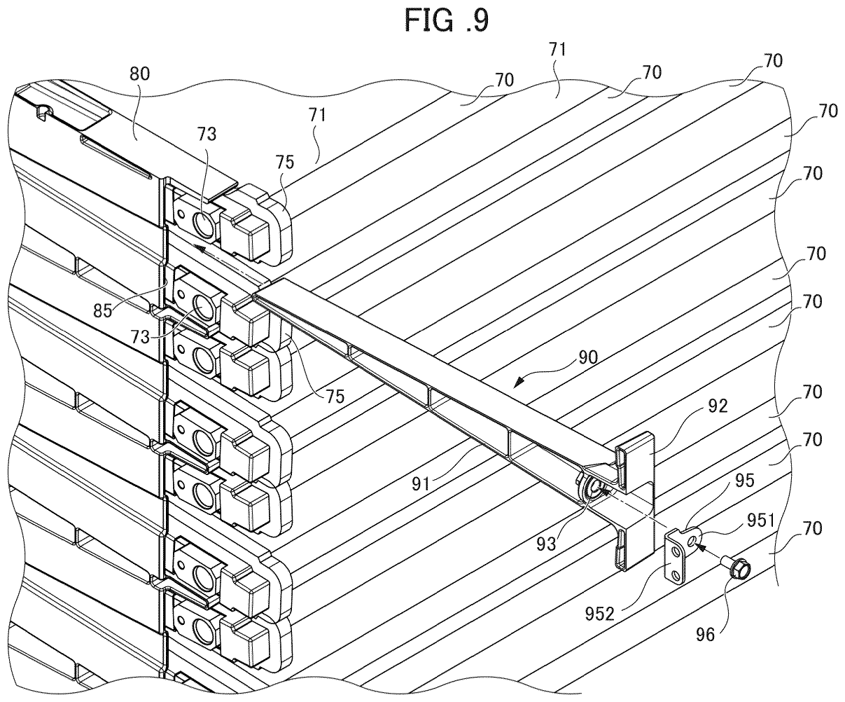

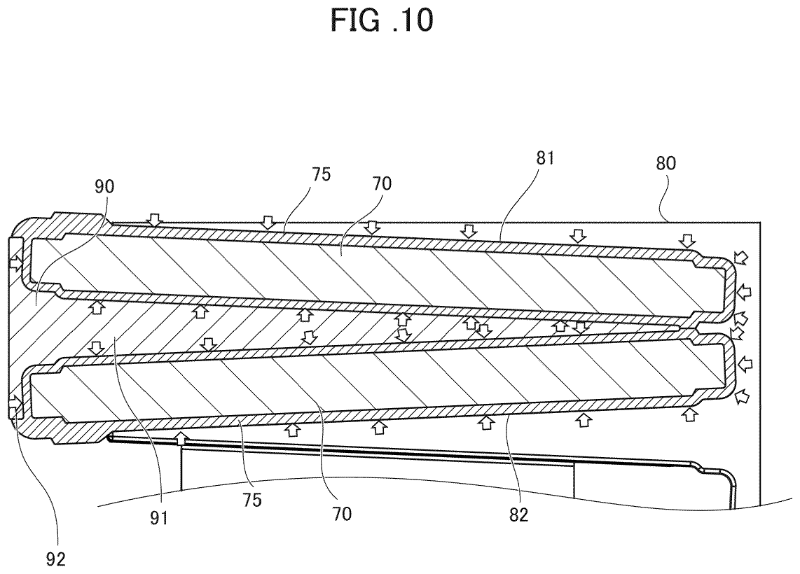

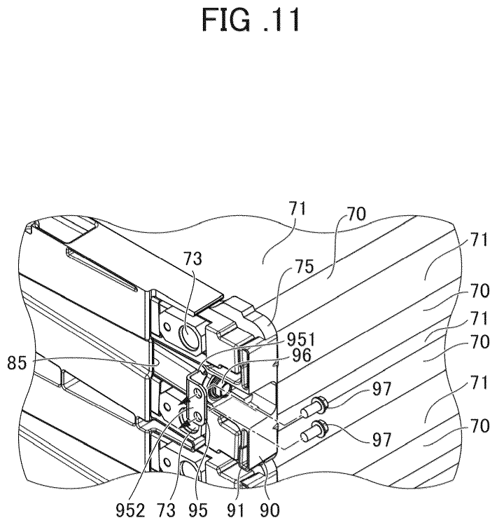

The flow path connection portion 73a is located adjacent to the leading end of the insertable portion 72 in the insertion direction. In a state in which the heat exchanger 70 is received in the first receiving portions 81 or the second receiving portions 82, the flow path connection portion 73a is connected to the header 110 through the connection through hole 84 described above (see FIG. 12). On the other hand, the flow path connection portion 73b is located adjacent to the back end in the insertion direction. In a state in which the heat exchanger 70 is received in the first receiving portions 81 or the second receiving portions 82, the flow path connection portion 73b is connected to the header 110 through the connection notch 85 described above (see FIGS. 9 and 11).

Each seal portion 75 is constituted by a compressive and deformable material that is deformed to follow another material or member. Examples of the material constituting the seal portions 75 include foamable porous materials such as urethane foam and the like. Air bubbles contained in the seal portions 75 can reduce heat transfer from the heat exchanger 70 to the support plates 80. In addition, since the air bubbles contained in the seal portions 75 can impart a cushioning function, each heat exchanger 70 on the support plates 80 can be further stabilized in position. From among the foamable materials, using a material with micro foam makes it possible to reduce deformation of the seal portions 75 under a reduced pressure in the desorption process.

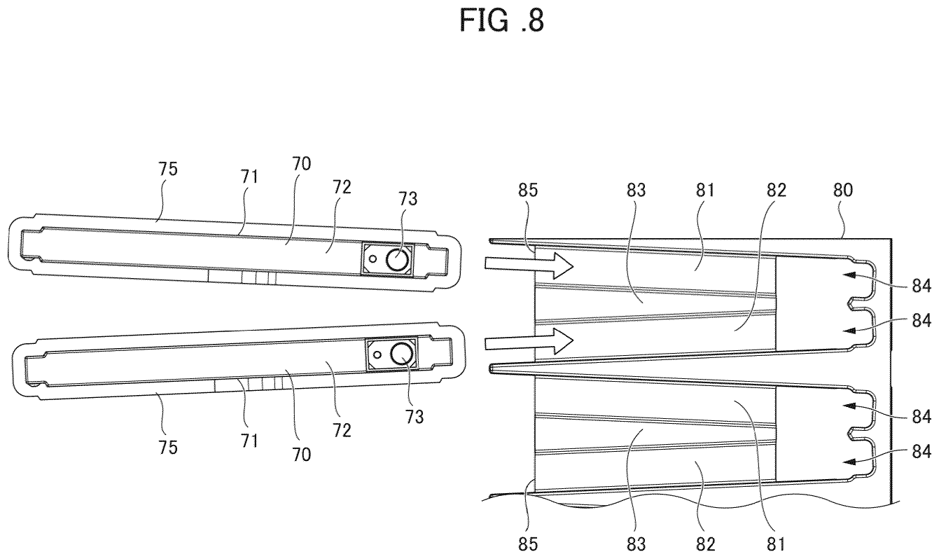

FIG. 8 is a schematic view illustrating a state in which the heat exchangers 70 are going to be received on the support plate 80 of the carbon dioxide recovery apparatus 1 of the present embodiment. FIG. 8 illustrates a state in which the heat exchangers 70 are going to be received in the first receiving portion 81 and the second receiving portion 82 of the support plate 80, respectively. Since the first receiving portion 81 is inclined, the heat exchanger 70 is inserted into the first receiving portion 81 in a state in which the leading end in the insertion direction is inclined downward by about 2.5 degrees. In this insertion process, the seal portion 75 on the insertable portion 72 of the heat exchanger 70 is deformed to follow the shape of the inner wall surface of the first receiving portion 81. Since the second receiving portion 82 is also inclined, the heat exchanger 70 is inserted into the second receiving portion 82 in a state in which the leading end in the insertion direction is inclined upward by about 2.5 degrees. Also in this insertion process, the seal portion 75 on the insertable portion 72 of the heat exchanger 70 is deformed to follow the shape of the inner wall surface of the second receiving portion 82.

In the carbon dioxide recovery apparatus 1 of the present embodiment, one guide member 90 is used to fix two heat exchangers 70 in the first and second receiving portions 81 and 82 in the received state. The guide member 90 is inserted between the first receiving portion 81 and the second receiving portion 82 of the support plate 80. Since the guide members 90 are disposed on the left and right sides, a total of ten guide members 90 are used in the present embodiment.

FIG. 9 is a perspective view illustrating one guide member 90 that is going to be inserted into the support plate 80 of the carbon dioxide recovery apparatus 1 of the embodiment. As illustrated in FIG. 9, the guide member 90 is inserted into the support plate 80 in a state in which the first receiving portion 81 and the second receiving portion 82 respectively have the heat exchangers 70 received therein.

As illustrated in FIG. 9, the guide member 90 has a substantially T-shape as a whole. The guide member 90 includes an insertable portion 91 extending in the insertion direction, a back end portion 92 provided at a back end of the insertable portion 91 and extending in a direction orthogonal to the insertion direction, and a bolt fastening portion 93 formed on an insertion side with respect to the back end portion 92.

The insertable portion 91 has a wedge shape tapered toward its leading end. In the present embodiment, the insertable portion 91 is made of resin, and has a thinned surface portion that faces outward when the guide member 90 is inserted into the support plate 80. However, in a case where the insertable portion 91 is made of metal or the like, the surface portion do not have to be thinned.

FIG. 10 is a schematic view illustrating a state in which the heat exchangers 70 and the guide member 90 are received on the support plate 80 of the carbon dioxide recovery apparatus 1 of the embodiment. As illustrated in FIG. 10, the insertable portion 91 is inserted between the heat exchanger 70 in the first receiving portion 81 and the heat exchanger 70 in the second receiving portion 82. In this insertion process, the seal portion 75 of each of the heat exchangers 70 is pressed by the insertable portion 91 and is deformed to follow the insertable portion 91.

In the inserted state, the back end portion 92 faces the front side of the heat exchanger 70 inserted in the first receiving portion 81 and the front side of the heat exchanger 70 inserted in the second receiving portion 82. Thus, in the insertion process, the back end portion 92 exerts a force to push the heat exchangers 70 received in the first and second receiving portions 81 and 82 in the insertion direction.

Upon insertion of the guide member 90, the seal portion 75 of the heat exchanger 70 in the first receiving portion 81 is sandwiched between, and is deformed to follow, the inner wall surface of the first receiving portion 81 and the guide member 90, and as a result, a gap between the heat exchanger 70 and the support plate 80 is closed. Likewise, the seal portion 75 of the heat exchanger 70 in the second receiving portion 82 is sandwiched between, and is deformed to follow, the inner wall surface of the second receiving portion 82 and the guide member 90, and as a result, a gap between the heat exchanger 70 and the support plate 80 is closed. As described above, the seal portions 75 made of foamed resin are crushed to seal the gaps between the heat exchangers 70 and the support plate 80. In the received state, the first receiving portion 81, the second receiving portion 82, and the guide member 90 apply a restraining force to the seal portions 75, as indicated by the open arrows. As described above, the carbon dioxide recovery apparatus 1 has a floating structure in which the heat exchangers 70 are supported by the support plates 80 and the guide members 90 via the seal portions 75.

Returning to FIG. 9, the bolt fastening portion 93 will be described. The bolt fastening portion 93 is located on the central axis of the insertable portion 91, and a fixing plate 95 for fixing the guide member 90 in position is fastened to the bolt fastening portion 93 with a fastening member 96.

The fixing plate 95 includes a first plate-shaped portion 951 facing in the insertion direction of the guide member 90, and a second plate-shaped portion 952 orthogonal to the first plate-shaped portion 951 and facing the inner side surface of the casing 50. The fastening member 96 includes, for example, a bolt, a washer, and the like, and fastens one plate-shaped portion of the fixing plate 95 to the guide member 90 in the insertion direction.

FIG. 11 is a perspective view illustrating how the guide member 90 is fixed after being inserted into the support plate 80 of the carbon dioxide recovery apparatus 1 of the embodiment. As illustrated in FIG. 11, in a state in which the guide member 90 has been inserted between the heat exchanger 70 in the first receiving portion 81 and the heat exchanger 70 in the second receiving portion 82, the guide member 90 is fixed to the casing 50.

In the present embodiment, the guide member 90 is fixed to the casing 50 via the fixing plate 95 fixed to the guide member 90. The second plate-shaped portion 952 of the fixing plate 95 is fixed to the casing 50 (not shown in FIG. 11) with a fastening member 97 including a bolt, a washer, and the like. The guide member 90 may be directly fixed to the casing 50, or may be fixed to the casing 50 via another member such as a fitting.

### <Structure for Connecting Heat Exchangers and Headers>

Next, a structure for circulating the heat transfer medium to the heat exchangers 70 supported on the support plates 80 inside the casing 50 will be described. The header 110 to which the inflow line 2 is connected and the header 110 to which the outflow line 3 is connected have the same structure.

FIG. 12 is a schematic view illustrating a structure for connecting the heat exchangers 70 and the header 110 of the carbon dioxide recovery apparatus 1 of the embodiment. FIG. 12 illustrates, in a cross section, the heat exchangers 70 respectively received in the lowermost first and second receiving portions 81 and 82, and the guide member 90. The cross section in FIG. 12 corresponds in position to the flow path connection portions 73 of the heat exchangers 70.

As illustrated in FIG. 12, flanged pipes 120 each of which connects the header 110 and the flow path connection portion 73 are disposed in a side wall of the casing 50. The plurality of flanged pipes 120 are disposed in accordance with the number of heat exchangers 70. Each of the headers 110 and the flanged pipes 120 is preferably made of a resin material having a low heat transfer coefficient.

Each flanged pipe 120 includes a cylindrical portion 121 through which the heat transfer medium flows, and a flange 125 sandwiched between the header 110 and the casing 50.

The cylindrical portion 121 has an end portion that is closer to the outside of the casing 50 with respect to the flange 125 and that is connected to the interior of the header 110 through a wall of the header 110, and a portion that is closer to the interior of the casing 50 with respect to the flange 125 and is connected to the flow path connection portion 73 through a wall of the casing 50.

An O-ring 122 is disposed on the cylindrical portion 121 at a position where the cylindrical portion 121 is connected to the flow path connection portion 73. The O-ring 122 is disposed in a groove formed on the outer peripheral surface of an end portion of the cylindrical portion 121 and is in contact with the inner peripheral surface of the flow path connection portion 73.

An O-ring 126 is disposed between the flange 125 and the header 110. The O-ring 126 is disposed in a groove formed on a surface of the flange 125 facing the outer side surface of the header 110, and is fixed so as to surround the outer side of the cylindrical portion 121.

An O-ring 127 is disposed between the flange 125 and the casing 50. The O-ring 127 is disposed in a groove formed on a surface of the flange 125 facing the outer side surface of the header 110, and is fixed so as to surround the outer side of the cylindrical portion 121.

As described above, the carbon dioxide recovery apparatus 1 of the present embodiment includes: heat exchangers (adsorbent holders) 70 that hold an adsorbent 12; support plates (supports) 80 that have a first receiving portion 81 and a second receiving portion 82 into which the heat exchangers 70 can be slidably inserted; and seal portions 75 that are disposed on the heat exchangers 70 and are deformed to follow the first receiving portion 81 and the second receiving portion 82 when the heat exchangers 70 are slidably inserted into the first receiving portion 81 and the second receiving portion 82, and the heat exchangers 70 are supported by the support plate 80 via the seal portions 75.

Due to this feature, a structure that allows for insertion of the heat exchangers 70 from one side even in a state in which other components remain assembled can be achieved by means of a simple configuration in which the heat exchangers 70 are held in a floating manner by the support plates 80 via the seal portions 75. In addition, in the process of inserting the heat exchangers 70 into the first receiving portion 81 and the second receiving portion 82, the seal portions 75 are crushed to fill gaps between the heat exchangers 70 and the support plates 80, thereby making it possible to ensure heat insulation and watertightness and to control the flow of air passing through the interior of the housing 10. Moreover, the seal portions 75, which are deformed to follow another component or material, can absorb the variation (tolerances) in the front-rear direction and the left-right direction of the heat exchangers 70, so that the carbon dioxide recovery apparatus 1 with stable quality can be achieved.

According to the present embodiment, each seal portion 75 is made of a foamable material.

Due to this feature, each seal portion 75, which is made of a porous material containing air bubbles formed therein, can be deformed with good followability without being caught by the first receiving portion 81 or the second receiving portion 82 when the heat exchanger 70 is inserted. Therefore, the heat exchangers 70 can be smoothly inserted, and the sealing performance and the heat insulating performance after the insertion can be further improved.

In the carbon dioxide recovery apparatus 1 of the present embodiment, one of the heat exchangers 70 is received in the first receiving portion 81, another of the heat exchangers 70 is received in the second receiving portion 82 located next to the first receiving portion 81, and the carbon dioxide recovery apparatus 1 further includes a guide member 90 that is inserted between the heat exchangers 70 received in the first and second receiving portions 81 and 82, and that presses the seal portions 75 of the heat exchangers 70.

Due to this feature, the heat exchangers 70 in the two receiving portions, i.e., the first receiving portion 81 and the second receiving portion 82, can be fixed by the guide member 90, and the configuration of the apparatus 1 can be made compact while maintaining the force for holding the heat exchangers 70.

In the present embodiment, the first receiving portion 81 is inclined such that a leading end of the first receiving portion 81 in the insertion direction of the heat exchanger 70 is closer to the second receiving portion 82 than a back end of the first receiving portion 81 in the insertion direction, the second receiving portion 82 is inclined such that a leading end of the second receiving portion 82 in the insertion direction is closer to the first receiving portion 81 than a back end of the second receiving portion 82 in the insertion direction, and the guide member 90 has a wedge shape tapered toward a leading end in the insertion direction.

Due to this feature, as a result of insertion of the wedge-shaped guide member 90 between the inclined first receiving portion 81 and the inclined second receiving portion 82, a strong force acts to cause the guide member 90 to press the seal portions 75 toward the first receiving portion 81 and the second receiving portion 82, whereby adhesion between the seal portion 75 and the first receiving portion 81 and adhesion between the seal portion 75 and the second receiving portion 82 can be effectively enhanced.

The carbon dioxide recovery apparatus 1 of the present embodiment further includes: a header 110 through which a heat transfer medium flows; a flanged pipe 120 that establishes communication between the interior of the heat exchanger 70 and the interior of the header 110 and allows the heat transfer medium to flow into the heat exchanger 70; and an O-ring 122 disposed between the heat exchanger 70 and the flanged pipe 120.

In a case where the heat exchanger 70 is in direct contact with another component, there will be a considerable heat loss due to heat transfer at the time of heating in the desorption process or the like. The present embodiment addresses this issue by means of the O-ring 122 as a heat insulating material disposed between the heat exchanger 70 and the flanged pipe 120, thereby making it possible to reduce heat transfer from the heat exchanger 70 to another component and to ensure sealing performance. The O-ring 122 allows for formation of an air layer between the heat exchanger 70 and the flanged pipe 120, whereby heat dissipation can also be reduced.

The carbon dioxide recovery apparatus 1 of the present embodiment further includes: a casing 50 to which the support plates 80 are fixed; the header 110 which is disposed outside the casing 50 and through which the heat transfer medium flows; a cylindrical portion 121 which penetrates a wall of the casing 50 and establishes communication between the interior of the heat exchanger 70 and the interior of the header 110, an O-ring (heat insulating material) 126 which is disposed between a flange 125 and the casing 50, and an O-ring (heat insulating material) 127 disposed between the flange 125 and the header 110.

This feature, in which the O-ring 126 and the O-ring 127 as heat insulating materials are disposed between the casing 50 and the header 110, can reduce heat transfer from the heat exchanger 70 to the header 110 via the casing 50.

### Second Embodiment

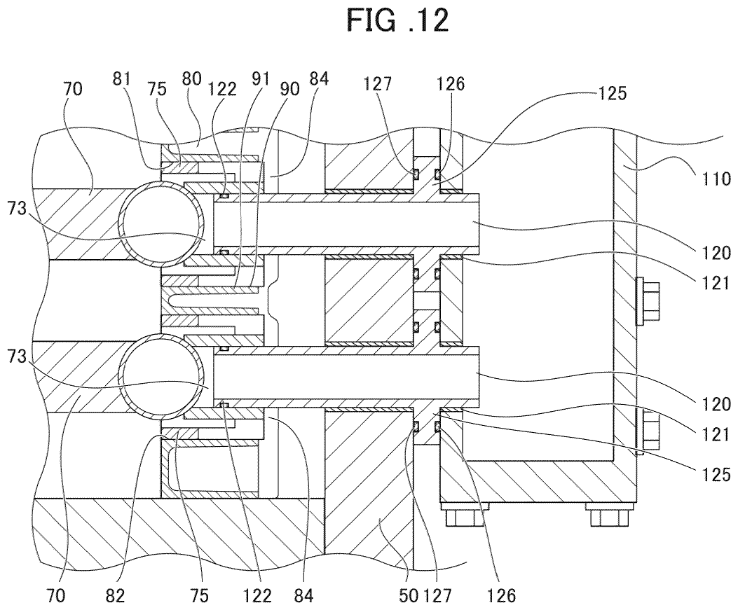

The second embodiment is similar to the first embodiment, except that a heat insulating material is added to the heat exchanger 70. Thus, components that are the same as those of the first embodiment described above are denoted by the same reference signs, and duplicate description thereof may be omitted. FIG. 13 is a diagram illustrating, on an enlarged scale, a portion of the heat exchanger 70. In the heat exchanger 70 illustrated in FIG. 13, a shape of the heat exchanger 70 is shown simplified and exaggerated. In particular, the thickness of the fins 78 is shown thicker than it actually is, and the shape of some of the fins 78 differs from that shown in FIG. 7. However, there is no essential difference between the heat exchanger 70 in the first embodiment and the heat exchanger 70 in the second embodiment, other than the presence or absence of the heat insulating material 79. In addition, the seal portion 75 is not shown in FIG. 13.

The heat exchanger main body 71 of the heat exchanger 70 further includes a side channel 76, flow paths 77 and fins 78, in addition to the insertable portion 72.

The side channel 76 is provided at the end of the insertable portion 72 extending in a direction intersecting the direction in which the insertable portion 72 extends, the side channel 76 configures the outer edge of the heat exchanger main body 71 together with the insertable portion 72.

A plurality of flow path 77 are crossed between a pair of the insertable portions 72 disposed at each end of the heat exchanger main body 71. The heat transfer medium flows through the inside of the flow path 77.

The fins 78 are formed by thin plate-shaped metal members, the fins 78 are arranged in a repeated folded form in space between the flow path 77 and the side channel 76, and space between one flow path 77 and the other flow path 77.

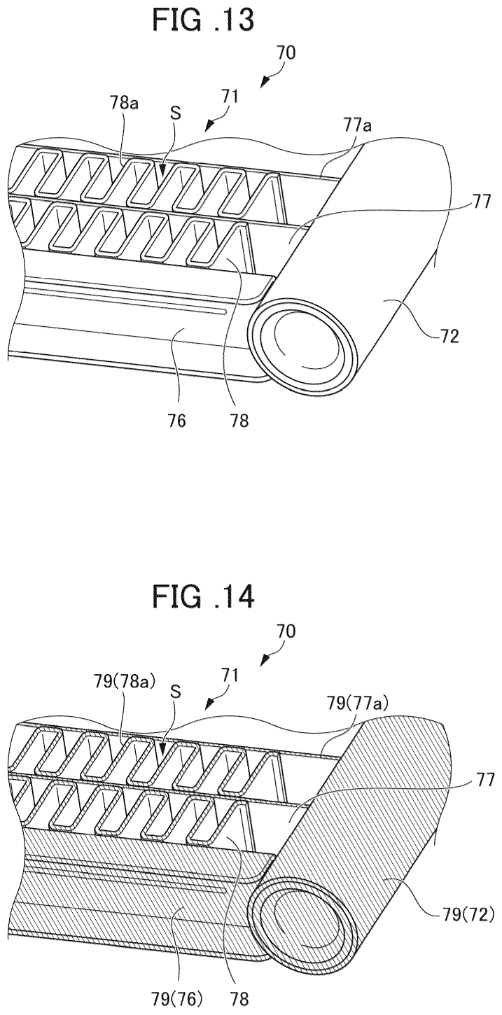

In an area surrounded by the insertable portion 72 and the side channel 76, voids S, which are portions other than the fins 78 and the flow paths 77, are filled with the adsorbent 12. Note that in FIGS. 13 and 14, the adsorbent 12 is omitted in order to clearly show the shape of the heat exchanger main body 71.

In the second embodiment, a heat insulating material 79 is provided on a surface of the heat exchanger main body 71 except for the voids S. In other words, the heat insulating material 79 is disposed on all parts of the surface of the heat exchanger main body 71 except for a part that is in contact with the adsorbent 12 of the heat exchanger main body 71. FIG. 14 is a diagram illustrating the heat insulating material 79 provided on the heat exchanger main body 79 of the heat exchanger 70. In FIG. 14, the heat insulating material 79 is represented by a hatched part. Specifically, the heat insulating material 79 is provided on a surface of the side channel 76, a surface of an end face 77a of the flow path 77, and a surface of an end face 78a of the fin 78. Note that the heat insulating material 79 is also provided on the back side of FIG. 14, i.e., on the surface of the end face of the the flow path 77 at the position opposite to the end face 77a of the flow path 77 and the end face of the fin 78 at the position opposite to the end face 78a of the fin 78.

The heat insulating material 79 is formed by coating a known coating type of heat insulating material, and drying the coated heat insulating material, for example. For example, a heat-cut powder etc. can be suitably used as the coating type of heat insulating material.

The provision of the heat insulating material 79 on the heat exchanger main body 71 prevents heat from being lost by heat transfer from the heat exchanger 70 to the outside, i.e., heat escapes, allowing the heat exchanger 70 to operate efficiently. In particular, at a part with which the heat exchanger 70 (the heat exchanger main body 71) is in contact, the effect of suppressing the escape of heat from the the heat exchanger 70 can be enhanced by the interposition of the the heat insulating material 79 at the contact part.

In second embodiment, the heat exchanger 70 has the seal portions 75 and is in contact with the support plate 80 and the guide member 90 through the seal portions 75. Although the seal portions 75 itself has a heat transfer suppressing effect, in the second embodiment, a higher heat insulating effect can be obtained by providing the heat insulating material 79 at the portion in contact with the seal portions 75. Thus, heat transfer to the seal portions 75 is suppressed, and further, heat transfer through the seal portions 75 to the support plate 80 and the guide member 90 can be suppressed, and high heat insulation can be achieved. Accordingly, the carbon dioxide recovery apparatus 1 according to the second embodiment is capable of achieving high thermal efficiency.

In addition, in the case where the seal portion 75 is less effective in suppressing heat transfer through the seal portions 75, or in the case where the seal portion 75 is not provided with a configuration equivalent to the seal portion 75, the importance of providing the heat insulating material 79 79 is even greater. Note that the second embodiment illustrates an example in which the heat insulating material 79 is disposed on all surfaces of the heat exchanger main body 71 except for the portion of the heat exchanger main body 71 in contact with the adsorbent 12. However, a portion provided on the heat insulating material 79 may be a portion of the surface of the heat exchanger main body 71 except for the portion of the heat exchanger main body 71 in contact with the adsorbent 12.

It should be noted that the present invention is not limited to the embodiments described above. The effects described in the above embodiments are merely examples of favorable effects, and the effects of the present invention are not limited to those described in the above embodiments. For example, a heat insulating material may be disposed on a part of the cylindrical portion 121 that penetrates a wall of the header 110 or a part of the cylindrical portion 121 that penetrates a wall of the casing 50.

### EXPLANATION OF REFERENCE NUMERALS

1: Carbon dioxide recovery apparatus
10: Housing
12: Adsorbent
70: Heat exchanger
75: Seal portion
79: heat insulating material
80: Support plate
81: First receiving portion
82: Second receiving portion
90: Guide member
120: Flanged pipe
121: Cylindrical portion
122: O-ring
125: Flange
125: O-ring
126: O-ring

What is claimed is:

1. A carbon dioxide recovery apparatus comprising:
an adsorbent holder holding an adsorbent;
a support having a receiving portion into which the adsorbent holder is able to be slidably inserted; and
a seal portion disposed on the adsorbent holder and capable of being deformed to follow the receiving portion when the adsorbent holder is slidably inserted into the receiving portion,
wherein the adsorbent holder is supported by the support via the sealing portion.

2. The carbon dioxide recovery apparatus according to claim 1, wherein the seal portion is made of a foamable material.

3. The carbon dioxide recovery apparatus according to claim 1, wherein
the adsorbent holder comprises a plurality of adsorbent holders, and
the receiving portion comprises:
a first receiving portion in which one of the plurality of adsorbent holders is received, and
a second receiving portion which is located next to the first receiving portion and in which another of the plurality of adsorbent holders is received,
the carbon dioxide recovery apparatus further comprising a guide member that is inserted between the adsorbent holders received in the first and second receiving portions, and that presses the seal portion of each of the adsorbent holders.

4. The carbon dioxide recovery apparatus according to claim 3, wherein
the first receiving portion is inclined such that a leading end of the first receiving portion in an insertion direction of the adsorbent holder is closer to the second receiving portion than a back end of the first receiving portion in the insertion direction,
the second receiving portion is inclined such that a leading end of the second receiving portion in the insertion direction is closer to the first receiving portion than a back end of the second receiving portion in the insertion direction, and
the guide member has a wedge shape tapered toward a leading end in the insertion direction.

5. The carbon dioxide recovery apparatus according to claim 1, further comprising:
a header through which a heat transfer medium flows;
a pipe that establishes communication between an interior of the adsorbent holder and an interior of the header and allows the heat transfer medium to flow into the adsorbent holder; and
a heat insulating material disposed between the adsorbent holder and the pipe.

6. The carbon dioxide recovery apparatus according to claim 1, further comprising:
a casing to which the support is fixed;
a header which is disposed outside the casing and through which a heat transfer medium flows;
a cylindrical portion penetrating a wall of the casing and establishing communication between an interior of the adsorbent holder and an interior of the header;
a flange provided on the cylindrical portion and disposed between the header and the casing; and
a heat insulating material disposed in at least one of a portion between the flange and the casing or a portion between the flange and the header.

7. The carbon dioxide recovery apparatus according to claim 1, further comprising a heat insulating material disposed on at least part of a surface of the adsorbent holder.

8. The carbon dioxide recovery apparatus according to claim 1, further comprising a heat insulating material disposed on all surfaces of the adsorbent holder except for a portion in contact with the adsorbent.
